(19) United States
(12) Patent Application Publication
(10) Pub. No.: US 2024/0231009 A1
(43) Pub. Date: Jul. 11, 2024

(54) BACKPOST AND OPTICAL CONNECTOR USING THE SAME

(71) Applicant: Mei-Miao LIU, Taipei City (TW)

(72) Inventor: Mei-Miao LIU, Taipei City (TW)

(21) Appl. No.: 18/406,092

(22) Filed: Jan. 6, 2024

(30) Foreign Application Priority Data
Jan. 7, 2023 (TW) 112100775

(51) Int. Cl. G02B 6/38

(52) U.S. Cl. CPC G02B 6/3831

(57) ABSTRACT

The present invention provides a backpost for optical connector, comprising a supporting base and a pair of latching arms. The supporting base comprises a through hole allowing a communicating wire passing therethrough. The pair of the latching arms are arranged at the two sides of the through hole, and each latching arm comprises a plurality of structure segments connecting with each other. Alternatively, in another embodiment, the present further provides an optical connector utilizing the backpost, wherein the plurality of structure segments extend the length of the latching arms without changing the length of the backpost, such that the flexibility of the material selection for making the backpost is increased, the design of the backpost can be optimized and the latching force is also improved.

### CROSS-REFERENCE TO RELATED APPLICATION

This application claims the benefit of Taiwan Patent Application No. 112100775, filed on Jan. 7, 2023, in the Taiwan Intellectual Property Office of the R.O.C, the disclosure of which is incorporated herein in its entirety by reference.

### FIELD OF INVENTION

The present invention relates to a backpost. In particular, it relates to a backpost and an optical connector using the same.

### BACKGROUND OF THE INVENTION

Due to the advantages of high frequency bandwidth and low loss, optical fibers have been widely used as signal transmission media in recent years. The use of optical fiber has already had a major revolutionary impact in the communications industry. Nowadays, 100G optical module communication is not enough, and the future will be expected to move towards the era of 400G optical module communications.

In order to achieve the goal, the optical connector with optical fiber transmission medium has become the main force for the data center to increase the amount of data and the growth of the transmission rate. However, in some usage scenarios, such as transmission towers or relay stations, in addition to using optical fibers to transmit information, wires for transmitting power are also required to supply power to receivers and transmitters. Based on this demand, there are optical connector products on the market that can transmit optical signals and power at the same time.

Please refer to FIG. 1, the conventional technology teaches a backpost of an MPO optical connector to solve the problem of lateral pulling force when the optical connectors are combined. The conventional backpost 1 has an I-shaped body 10 with a reinforced rib 11 on one side of the body 10. The I-shaped body 10 has a pair of latching arms 13 extending toward the support base 12, the pair of latching arms 13 are fastened on the upper and lower sides the ribs 11, the free ends of the latching arms 13 has latching elements 14.

The above information disclosed in this section is only for enhancement of understanding of the background of the described technology and therefore it may contain information that does not form the prior art that is already known to a person of ordinary skill in the art.

### SUMMARY OF THE INVENTION

The present invention provides a backpost for an optical connector and the optical connector using the same, within a limited range of latching length, a latching arm is formed by connecting multiple structure segments, and a latching element is disposed at a free end of the latching arm. Since the latching arm is connected by multiple structure segments, the latching arm can be greatly increased without affecting the length of the overall element, thereby increasing the flexibility of the selected materials and optimizing the structure design, making the latching arm more flexible. The combined strength of the latching arms is also enhanced.

The present invention provides a backpost for an optical connector, comprising: a supporting base, having a through hole to allow a communication wire to pass through; and a pair of latching arms, disposed on a first side of the supporting base and located on both sides of the through hole, the each latching arm having a plurality of structure segments connected with each other.

The present invention also provides an optical connector, comprising: a housing, having an accommodation channel; a terminal portion, disposed into the accommodation channel, having a first side and a second side, wherein the first side has a plurality of signal coupling portions; a first elastic element, having a first leaning end and a second leaning end, wherein the first leaning end is leaned against the second leaning end; and a backpost, leaned against the second leaning end. Furthermore, the backpost comprises: a supporting base, having a through hole to allow a communication wire to pass through; and a pair of latching arms, disposed on a first side of the supporting base and located on both sides of the through hole, the each latching arm having a plurality of structure segments connected with each other.

The present invention will become better understood with reference to the following detailed description considered in connection with the accompanying drawings.

### BRIEF DESCRIPTION OF THE DRAWINGS

The detailed structure, operating principle and effects of the present invention will now be described in more details hereinafter with reference to the accompanying drawings that show various embodiments of the present invention as follows.

FIG. 1 is a schematic diagram of a backpost used in a conventional optical connector.

FIG. 2 is a schematic diagram of an embodiment of the backpost used for the optical connector in the present invention.

FIG. 3 is a schematic diagram of another embodiment of the backpost used for the optical connector in the present invention.

FIG. 4 is a schematic diagram of an embodiment of the optical connector in the present invention.

FIG. 5 is a schematic diagram of an embodiment of an inner housing in the present invention.

FIG. 6 is a schematic diagram of an embodiment of the combination of the first elastic element and the backpost used for the optical connector in the present invention.

FIG. 7 is a schematic diagram of another embodiment of the combination of the first elastic element and the backpost used for the optical connector in the present invention.

FIGS. 8A and 8B are schematic diagrams of an embodiment of the combination of the outer housing and the inner housing of the optical connector in the present invention.

### DETAILED DESCRIPTION OF THE PREFERRED EMBODIMENTS

Reference will now be made in detail to the exemplary embodiments of the present invention, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this invention will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way.

For convenience, certain terms employed in the specification, examples and appended claims are collected here. Unless defined otherwise, all technical and scientific terms used herein have the same meaning as commonly understood by one of the ordinary skill in the art to which this invention belongs.

Various embodiments will now be described more fully with reference to the accompanying drawings, in which illustrative embodiments are shown. The inventive concept, however, may be embodied in various different forms, and should not be construed as being limited only to the illustrated embodiments. Rather, these embodiments are provided as examples, to convey the inventive concept to one skilled in the art. Accordingly, known processes, elements, and techniques are not described with respect to some of the embodiments.

The singular forms “a”, “and”, and “the” are used herein to include plural referents unless the context clearly dictates otherwise.

The following descriptions are provided to elucidate a backpost and an optical connector using the same and to aid it of skilled in the art in practicing this invention. These embodiments are merely exemplary embodiments and in no way to be considered to limit the scope of the invention in any manner.

Please refer to FIG. 2, which is a schematic diagram of an embodiment of the backpost used for the optical connector in the present invention. In this embodiment, the backpost 2 of the optical connector includes a supporting base 20 and a pair of latching arms 22. The supporting base 20 has a through hole 200 to allow communication wires to pass through. The latching arms 22 are respectively disposed on a first side A of the supporting base 20 and are located on both sides of the through hole 200. Each latching arm 22 further includes a plurality structure segments connected with each other. A casing 23 is connected to a second side B of the supporting base 20 and communicates with the through hole 200. The communication wire enters the through hole 200 through the casing 23. In this embodiment, the latching arm 22 has an extending plate 21 connected to the supporting base 20, and the plurality of structure segments further includes a first structure segment 220, a second structure segment 221, and a third structure segment 222. One end of the first structure segment 220 is connected to the extending plate 21, the second structure segment 221 is connected to the first structure segment 220, and the third structure segment 222 is connected to the second structure segment 221. The third structure segment 222 has a free end 223, a gap G is arranged between the free end 223 of the third structure segment 222 and the extending plate 21, and is maintained with a predetermined distance so that the latching arm 22 forms a U-shaped structure. It should be noted that the configuration of the latching arm 22 is not limited to the U-shape. It depends on the number of structure segments and the method of arrangement. For example, in another embodiment, the configuration of the latching arm 22 may also be L-shaped.

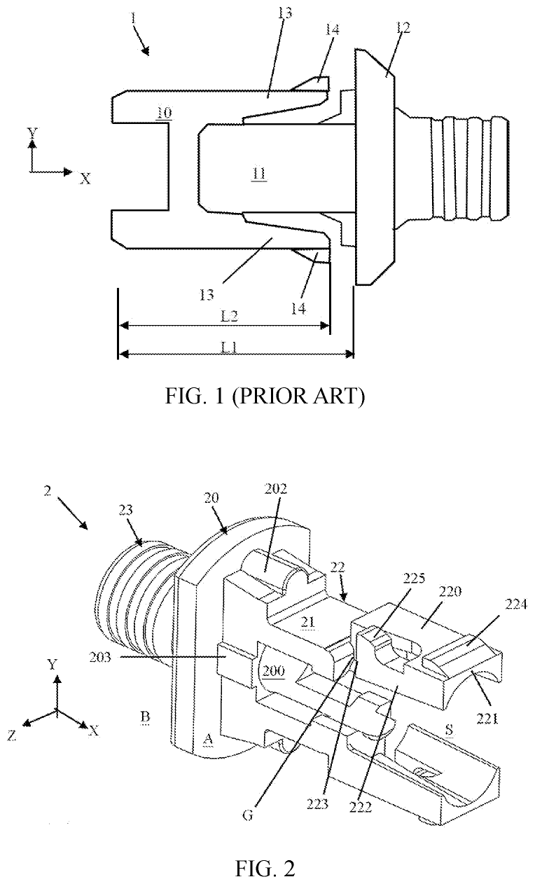

In this embodiment, a space S is arranged between the upper latching arm 22 and lower latching arm 22 to allow communication wires to pass through. In addition, the second structure segment 221 has a first latching element 224, and the third structure segment 222 has a second latching element 225, which is located on the free end 223 of the third structure segment 222. The first latching element 224 and the second latching element 225 are respectively used to buckle with the housing of the optical connector to strengthen the buckling force. In addition, in this embodiment, the supporting base 20 has a first positioning structure 202 and a second positioning structure 203, which are used for positioning with the housing of optical connector, so that the housing and the backpost can be combined stably. It should be noted that the first positioning structure 202 and the second positioning structure 203 do not have to be set at the same time. At least one of them can achieve the aforementioned effect, and the setting can be determined according to the needs of the user, and is not limited herein. In addition, with the design of the first positioning structure 202 and/or the second positioning structure 203, it's not necessary for the design of the rib 11 in the conventional technology shown in FIG. 1. Due to the design of the rib 11 in FIG. 1, an additional window needs to be opened on the housing of the optical connector, which increases the complexity of the mold design. On the contrary, the design of the first positioning structure 202 and/or the second positioning structure 203 in this embodiment can simplify and reduce the cost of the mold design.

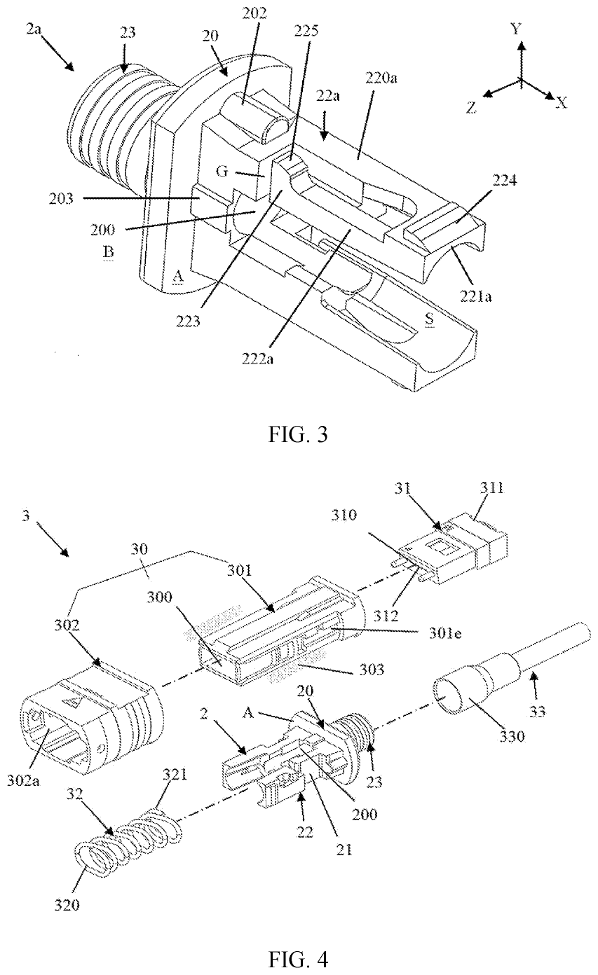

Please refer to FIG. 3, which is a schematic diagram of another embodiment of the backpost used for the optical connector in the present invention. The backpost 2a in this embodiment is similar to the aforementioned backpost 2, except for the design of the latching arms. In this embodiment, the latching arm 22a does not have an extending plate, but a plurality of structure segments are directly extended from the supporting base 20, the latching arm 22a has a first structure segment 220a, a second structure segment 221a, and a third structure segment 222a. One end of the first structure segment 220a is connected to the supporting base 20, the second structure segment 221a is connected to the first structure segment 220a, and the third structure segment 222a is connected to the second structure segment 221a. The third structure segment 222a has a free end 223, a gap G is arranged between the free end 223 of the third structure segment 222a and the supporting base 20, and is maintained with a predetermined distance. In this embodiment, a space S is arranged between the upper latching arm 22a and lower latching arm 22a to allow communication wires to pass through.

Next, the arrangement of the latching arm in the present invention will be described. In conventional technology, as shown in FIG. 1, the latching arm 13 is a simple extending structure, and the length L2 in the X-axis direction is almost equal to the length L1 used by the backpost 1 to generate the latching effect. On the contrary, in the design of the latching arm of the present invention, as shown in FIG. 2, the entire length of latching arm 22 is the sum of the lengths of the extending plate 21 and the structure segment in the X-axis direction. The plurality of structure segments has a first structure segment 220 extended in the X-axis direction, a second structure segment 221 extended in the Z-direction, and a third structure segment 222 extended in the −X-axis direction. Through the design of a plurality of structure segments 220˜222, the entire length of the latching arm 22 can be increased without affecting the length of backpost 2. Because the length of the latching arm 22 is increased, the types of materials that can be selected become more flexible, and the optimization degree of the design and the buckling strength of the latching arm have greater design choices.

Similarly, as shown in FIG. 3, the entire latching arm 22a is the sum of the lengths of multiple structure segments, wherein the plurality of structure segments include a first structure segment 220a extended in the X-axis direction, a second structure segment 221a extended in the Z-direction, and a third structure segment 222a extended in the −X-axis direction. Through the design of a plurality of structure segments 220a˜222a, the entire length of the latching arm 22a can be increased without affecting the length of backpost 2a. Because the length of the latching arm 22a is increased, the types of materials that can be selected become more flexible, and the optimization degree of the design and the buckling strength of the latching arm have greater design choices.

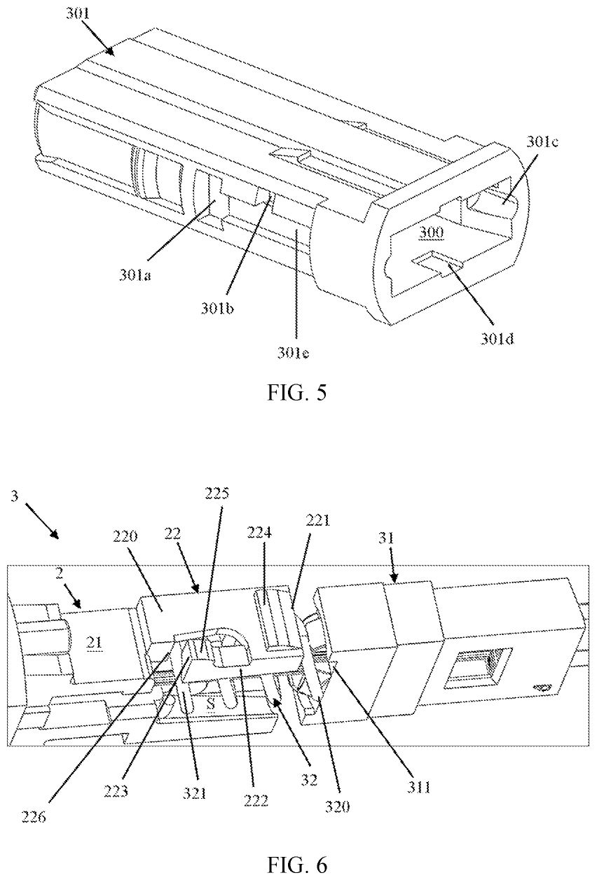

Please refer to FIGS. 2 to 4, wherein FIG. 4 is a schematic diagram of an embodiment of the optical connector in the present invention. In this embodiment, the optical connector 3 includes a housing 30, a terminal portion 31, a first elastic element 32 and a backpost 2. The housing 30 has an inner housing 301, a pair of second elastic elements 303 and an outer housing 302. The inner housing 301 has an accommodation channel 300 for accommodating the terminal portion 31 and the first elastic element 32, and buckling with the backpost 2. Please refer to FIG. 5, which is a schematic diagram of an embodiment of an inner housing in the present invention. In this embodiment, the inner housing 301 includes a first latching structure 301a, a second latching structure 301b, a third positioning structure 301c and a fourth positioning structure 301d, wherein the first latching structure 301a and the second latching structure 301b are arranged to buckle with the first latching element 224 and the second latching element 225 of the backpost 2 respectively, the backpost 2 achieves a more stable fixing effect through two latching structures. A third positioning structure 301c and a fourth positioning structure 301d are disposed at the opening of the accommodation channel 300 on a side where the inner housing 301 is combined with the backpost 2. When the backpost 2 is assembled with the inner housing 301, the first positioning structure 202 and the second positioning structure 203 are respectively embedded in the corresponding third positioning structure 301c and the fourth positioning structure 301d, so that the backpost 2 can be stably installed in the inner housing 301.

The inner housing 301 has accommodation grooves 301e disposed on both sides of the first latching structure 301a and the second latching structure 301b to respectively accommodate the second elastic elements 303, wherein one end of the second elastic element 303 is leaned against a wall surface of the accommodation groove 301e, and the other end of the second elastic element 303 is leaned against the inner wall of the outer housing 302. The terminal portion 31 is disposed in the accommodation channel 300. The terminal portion 31 has a first side 310 and a second side 311. The first side 310 has a plurality of signal coupling portions 312. In this embodiment, each signal coupling portion 312 has an optical fiber. The first elastic element 32 has a first leaning end 320 and a second leaning end 321. As shown in FIG. 6, the first leaning end 320 is leaned against the second side 311 of the terminal portion 31, and the second leaning end 321 is leaned against the backpost 2. In this embodiment, the second end 321 is inserted into the space S between the two latching arms 22, the second leaning end 321 is leaned against the side wall 226 of the first structure segment 220 within the space S, and the first end 320 is leaned against the second side 311 of the terminal portion 31. Please return to FIG. 4, the optical connector 3 has a protection casing 33, an end of casing opening 330 covers the casing 23 of the backpost 2. The communication wires extended from the casing 23 of the backpost 2 pass through the protection casing 33.

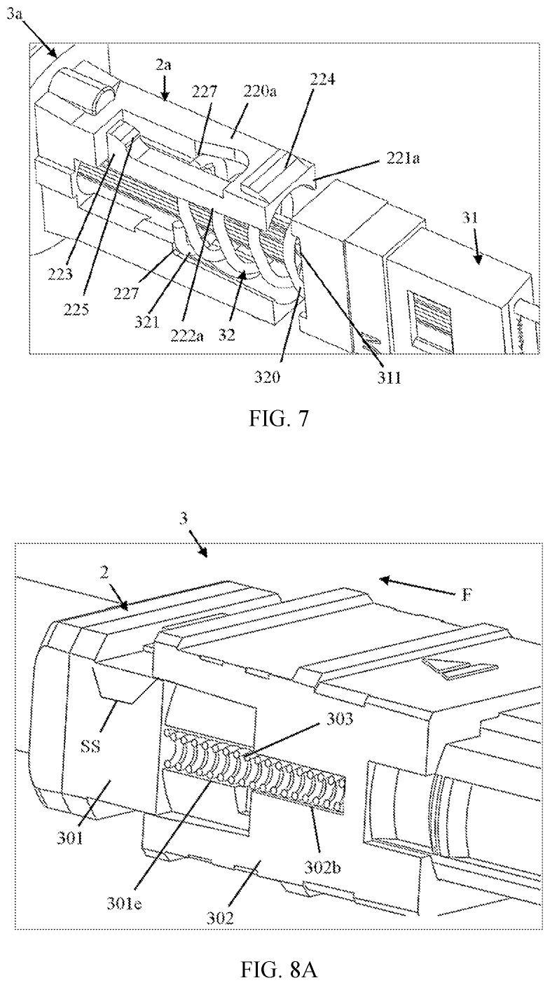

Please refer to FIG. 7, which is a schematic diagram of another embodiment of the combination of the first elastic element and the backpost used for the optical connector in the present invention. The optical connector 3a is similar to the aforementioned optical connector 3 shown in FIG. 6, except that the backpost is implemented from the backpost 2a shown in FIG. 3. In this embodiment, the bottom of the first structure segment 220a of the latching arm 22a has a blocking wall 227, which is leaned against the second end 321 of the first elastic element 32.

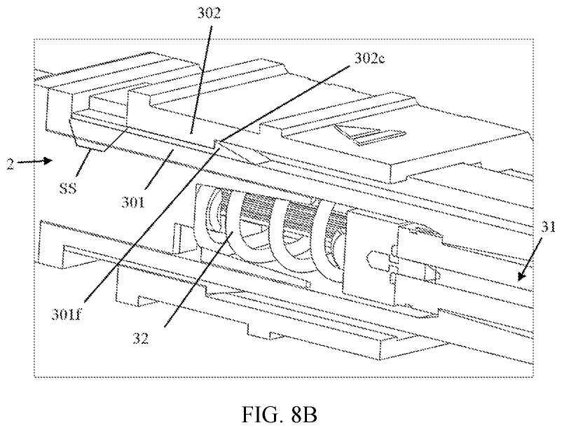

Returning to FIG. 4, the outer housing 302 is slidably disposed on the periphery of the inner housing 301. In this embodiment, the outer housing 302 has a through-hole slot 302a, and the inner housing 301 penetrates into the through-hole slot 302a. Please refer to FIGS. 8A and 8B, which are schematic diagrams of an embodiment of the combination of the outer housing and the inner housing of the optical connector in the present invention. In this embodiment, the outer housing 302 of the optical connector 3 has an accommodation groove 302b to accommodate a part of the second elastic element 303. In this embodiment, one end of the second elastic element 303 is leaned against the bottom surface of the accommodation groove 301e of the inner housing 301, and the other end of the second elastic element 303 is leaned against the bottom surface of the accommodation groove 302b of the outer housing 302. In addition, when the outer housing 302 and the inner housing 301 are slidably disposed together, the outer housing 302 has a first stopping structure 302c corresponding to the top surface of the inner housing 301 and the first stopping structure 302c is leaned against a second stopping structure 301f corresponding to inner housing 301, so that the outer housing 301 is positioned as shown in FIG. 8A. When the user applies a force F on the outer housing 302, the outer housing 302 is slid along an interval space SS. At this time, the second elastic element 303 would be compressed by sliding the outer housing 302. Once the force F is released, the elastic force accumulated in the second elastic element 303 is released, and the outer housing 302 can be rebounded to the original position as shown in FIG. 8A.

In summary, the present invention provides a backpost for an optical connector and the optical connector using the same, within a limited range of latching length, a latching arm is formed by connecting multiple structure segments, and a latching element is disposed at a free end of the latching arm. Since the latching arm is connected by multiple structure segments, the latching arm can be greatly increased without affecting the length of the overall element, thereby increasing the flexibility of the selected materials and optimizing the structure design, making the latching arm more flexible. The combined strength of the latching arms is also enhanced.

It will be understood that the above description of embodiments is given by way of example only and that various modifications may be made by those with ordinary skill in the art. The above specification, examples, and data provide a complete description of the present invention and use of exemplary embodiments of the invention. Although various embodiments of the invention have been described above with a certain degree of particularity, or with reference to one or more individual embodiments, those with ordinary skill in the art could make numerous alterations or modifications to the disclosed embodiments without departing from the spirit or scope of this invention.

What is claimed is:

1. A backpost for an optical connector, comprising:
a supporting base, having a through hole to allow a communication wire to pass through; and
a pair of latching arms, disposed on a first side of the supporting base and located on both sides of the through hole, the each latching arm having a plurality of structure segments connected with each other.

2. The backpost of claim 1, wherein the latching arm has an extending plate connected to the supporting base, the plurality of structure segments comprise:
a first structure segment, an end of the first structure segment connected to the extending plate;
a second structure segment, connected to the first structure segment; and
a third structure segment, connected to the second structure segment, having a free end, and separated from the extending plate by a predetermined distance.

3. The backpost of claim 2, wherein the second structure segment has a first latching element.

4. The backpost of claim 2, wherein the free end has a second latching element.

5. The backpost of claim 1, wherein the plurality of structure segments comprise:
a first structure segment, an end of the first structure segment connected to the supporting base;
a second structure segment, connected to the first structure segment; and
a third structure segment, connected to the second structure segment, having a free end, and separated from the supporting base by a predetermined distance.

6. The backpost of claim 5, wherein the second structure segment has a first latching element.

7. The backpost of claim 5, wherein the free end has a second latching element.

8. The backpost of claim 1, wherein the supporting base has at least one positioning structure.

9. An optical connector, comprises:
a housing, having an accommodation channel;
a terminal portion, disposed into the accommodation channel, having a first side and a second side, wherein the first side has a plurality of signal coupling portions;
a first elastic element, having a first leaning end and a second leaning end, wherein the first leaning end is leaned against the second leaning end; and
a backpost, leaned against the second leaning end, wherein the backpost comprises:
a supporting base, having a through hole to allow a communication wire to pass through; and
a pair of latching arms, disposed on a first side of the supporting base and located on both sides of the through hole, the each latching arm having a plurality of structure segments connected with each other.

10. The optical connector of claim 9, wherein the latching arm has an extending plate connected to the supporting base, the plurality of structure segments comprise:
a first structure segment, an end of the first structure segment connected to the extending plate;
a second structure segment, connected to the first structure segment; and
a third structure segment, connected to the second structure segment, having a free end, and separated from the extending plate by a predetermined distance.

11. The optical connector of claim 10, wherein the second structure segment has a first latching element.

12. The optical connector of claim 10, wherein the free end has a second latching element.

13. The optical connector of claim 9, wherein the plurality of structure segments comprise:
a first structure segment, an end of the first structure segment connected to the supporting base;
a second structure segment, connected to the first structure segment; and
a third structure segment, connected to the second structure segment, having a free end, and separated from the supporting base by a predetermined distance.

14. The optical connector of claim 13, wherein the second structure segment has a first latching element.

15. The optical connector of claim 13, wherein the free end has a second latching element.

16. The optical connector of claim 9, wherein the supporting base has at least one positioning structure.

17. The optical connector of claim 9, wherein the housing comprises:
an inner housing, having an accommodation channel;
a pair of second elastic elements, respectively disposed on both sides of the inner housing; and
an outer housing, having a through-hole slot, the inner housing penetrating into the through-hole slot, the inner walls on both sides of the outer housing leaned against the pair of second elastic elements to allow the outer housing moving relative to the inner housing.
